(19) United States
(12) Patent Application Publication
(10) Pub. No.: US 2021/0242448 A1
(43) Pub. Date: Aug. 5, 2021

(54) BATTERY NEGATIVE ELECTRODE MATERIAL, METHOD FOR MANUFACTURING SAME, NEGATIVE ELECTRODE FOR SECONDARY BATTERY, AND SECONDARY BATTERY

(71) Applicants: Kureha Corporation, Tokyo (JP); Panasonic Corporation, Osaka (JP)

(72) Inventors: Makoto IMAJI, Tokyo (JP); Yukitaro SAKAKIBARA, Tokyo (JP); Shota KOBAYASHI, Tokyo (JP); Kenichi HOTEHAMA, Osaka (JP); Daisuke KATOU, Osaka (JP); Ryohei MIYAMAE, Osaka (JP)

(73) Assignees: Kureha Corporation, Tokyo (JP); Panasonic Corporation, Osaka (JP)

(21) Appl. No.: 17/222,113

(22) Filed: Apr. 5, 2021

Related U.S. Application Data
(62) Division of application No. 16/245,987, filed on Jan. 11, 2019.

(30) Foreign Application Priority Data
Jan. 12, 2018 (JP) 2018-003519

(51) Int. Cl. H01M 4/1393; H01M 4/04; H01M 10/0525; H01M 4/38; H01M 4/587; H01M 4/36; H01M 4/133; H01M 4/134; H01M 4/1395

(52) U.S. Cl. CPC H01M 4/1393; H01M 4/0428; H01M 10/0525; H01M 4/386; H01M 4/1395; H01M 4/366; H01M 4/133; H01M 4/364; H01M 4/134; H01M 4/587

(57) ABSTRACT

Provided is a battery negative electrode material exhibiting both a merit of high specific capacity obtained by using Si, and a merit of high cycle durability obtained by using a non-graphitizable carbon material. Specifically, provided is a negative electrode material (1) of a battery that includes silicon material areas (10) made of a silicon material, and a carbon material area (20) made of a carbon material. The carbon material area (20) is formed in a surrounding area of the silicon material area (10), separated by a cavity (30) at least at a portion. In addition, an (002) average interlayer spacing d₀₀₂ of the carbon material area (20) determined by powder X-ray diffraction is from 0.365 nm to 0.390 nm. The battery negative electrode material 1 is manufactured through: a step (a) of melting and mixing or dissolving and mixing with an organic material composition, a coated silicon material that has been coated with silicon oxide; a step (b) of removing the silicon oxide; and a step (c) of carbonizing an organic material constituting the organic material composition.

### CROSS-REFERENCE TO RELATED APPLICATIONS

This application is a Divisional of copending application Ser. No. 16/245,987, filed on Jan. 11, 2019, which claims priority under 35 U.S.C. § 119(a) to Application No. 2018-003519, filed in Japan on Jan. 12, 2018, all of which are hereby expressly incorporated by reference into the present application.

### TECHNICAL FIELD

The present invention relates to a battery negative electrode material, a method for manufacturing the same, a negative electrode for a secondary battery, and a secondary battery.

### BACKGROUND ART

Carbonaceous materials are used as negative electrode materials of lithium-ion secondary batteries, and graphite materials and amorphous carbon materials are particularly used. However, graphite has a theoretical limit with a theoretical capacity of 372 mAh/g. Furthermore, some amorphous carbons exhibit a larger capacity than graphite. However, the density of amorphous carbon is low, and therefore the capacity per volume is a level that is equivalent to that of graphite. Thus, a desire exists to further increase the discharge capacity.

Meanwhile, tin, silicon and other materials are being proposed as materials that exhibit higher capacities than graphite and amorphous carbon materials. However, a problem with these materials is that they expand significantly during charging, and are inferior in cycle durability. In the midst of these types of circumstances, Patent Document 1 proposes a negative electrode material that exhibits both high capacity and high cycle durability by forming cavities around silicon.

### CITATION LIST

### Patent Literature

Patent Document 1: WO 2013/031993

### SUMMARY OF INVENTION

### Technical Problem

However, upon examination, the present inventors confirmed that the negative electrode material described in Patent Document 1 forms a very thin carbon coating layer along with the formation of cavities, and thus the layer is fractured by the pressing treatment after the electrode is produced. Therefore, a problem of the negative electrode material of Patent Document 1 is that the material exhibits inferior cycle durability in actual usage conditions.

### Solution to Problem

In order to solve this type of problem, the present inventors conducted diligent research, and discovered that by carrying out the following steps (a) to (c), a battery negative electrode material that uses a non-graphitizable carbon material as the material configuring the area surrounding the spaces around Si while maintaining those spaces is obtained, and thereby the present inventors arrived at the completion of the present invention. Specifically, the present invention provides the following.

(1) The present invention is a battery negative electrode material containing: silicon material areas of a silicon material; and a carbon material area of a carbon material, formed in a surrounding area of the silicon material areas, separated by cavities at least at a portion; wherein an (002) average interlayer spacing d₀₀₂ of the carbon material area determined by powder X-ray diffraction using CuKα rays is from 0.365 nm to 0.390 nm.

(2) In addition, the present invention is the battery negative electrode material according to (1), wherein a percentage of a surface area of the cavities with respect to a cross-sectional area when a cross-section is observed with a scanning electron microscope (SEM) is from 2% to 30%.

(3) In addition, the present invention is the battery negative electrode material according to (1) or (2), wherein the content of silicon material is from 5 mass % to 30 mass % per 100 mass % of the negative electrode material; and the content of the carbon material is from 70 mass % to 95 mass % per 100 mass % of the negative electrode material.

(4) Furthermore, the present invention is the battery negative electrode material according to any of (1) to (3), wherein a true density (ρ_{He}) measured in accordance with the JIS R1620(4) gas displacement method using helium as a displacement medium is from 1.30 g/cm³ to 1.90 g/cm³.

(5) Moreover, the present invention is the battery negative electrode material according to any of (1) to (4), wherein a maximum particle size of the silicon material is 1000 nm or less.

(6) The present invention is a method for manufacturing a battery negative electrode material containing silicon material areas of a silicon material, and a carbon material area of a carbon material, formed in a surrounding area of the silicon material areas, separated by cavities at least at a portion, with an (002) average interlayer spacing d₀₀₂ of the carbon material area determined by powder X-ray diffraction using CuKa rays being from 0.365 nm to 0.390 nm; the method including the following steps (a) to (c).

Step (a): Melting and mixing or dissolving and mixing with an organic material composition, a coated silicon material that has been coated with silicon oxide.

Step (b): Removing the silicon oxide.

Step (c): Carbonizing an organic material constituting the organic material composition.

(7) In addition, the present invention is a negative electrode for a secondary battery, the electrode containing the negative electrode material according to any of (1) to (5).

(8) Furthermore, the present invention is a secondary battery having the negative electrode according to (7).

### Advantageous Effects of Invention

According to the present invention, a battery negative electrode material further excelling in both specific capacity and cycle durability can be provided.

### BRIEF DESCRIPTION OF THE DRAWINGS

FIGS. 1A and 1B are schematic views of a battery negative electrode material 1 according to the present embodiment; FIG. 1A is a schematic view of the battery negative electrode material 1 in an uncharged state, and FIG. 1B is a schematic view of the battery negative electrode material 1 in a charged state.

### DESCRIPTION OF EMBODIMENTS

Hereinafter, specific embodiments of the present invention will be described. The present invention is not limited in any way by the following embodiments, and appropriate modifications can be implemented within the targeted scope of the present invention.

### 1. Battery Negative Electrode Material

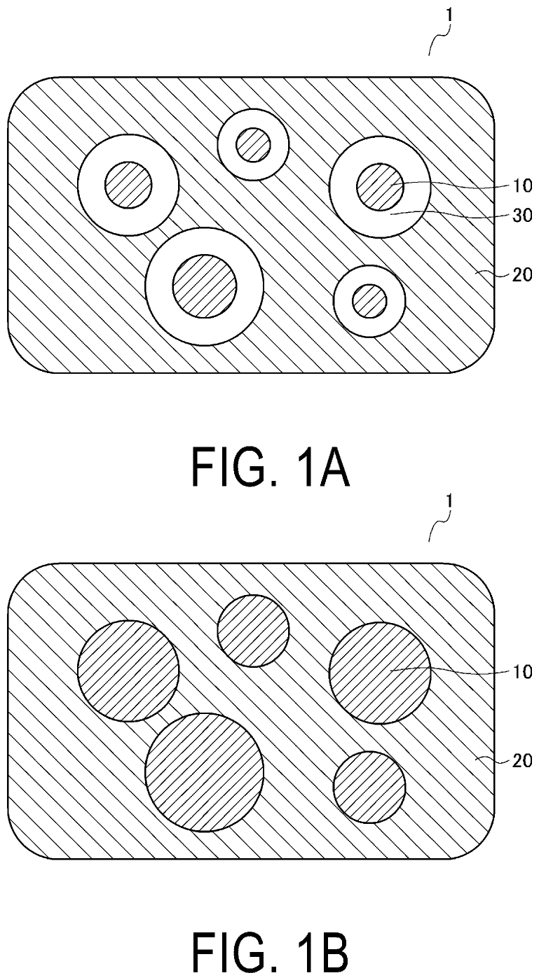

FIGS. 1A and 1B are schematic views of a battery negative electrode material 1 according to the present embodiment. More specifically, FIG. 1A is a schematic view of the battery negative electrode material 1 in an uncharged state, and FIG. 1B is a schematic view of the battery negative electrode material 1 in a charged state.

The battery negative electrode material 1 is provided with silicon material areas 10 made of a silicon material, and a carbon material area 20 made of a carbon material. The carbon material area 20 is formed in surrounding areas of the silicon material areas 10, separated by cavities 30 at least at a portion. Furthermore, in addition to the abovementioned cavities 30, portions made from only a cavity may be present in the carbon material area 20.

As illustrated in FIG. 1A, in a de-doped state (non-charged state) of metal ions such as lithium ions contained in the electrolyte, the silicon material in the silicon material area 10 is contracted, and at least some of the areas between the silicon material areas 10 and the carbon material area 20 are separated by cavities 30.

On the other hand, as illustrated in FIG. 1B, in a doped state (charged state) of the metal ions, the silicon material in the silicon material areas 10 expands, and an alloy of lithium and silicon material occupies the cavity.

### Silicon Material Area

The silicon material area 10 is configured from a silicon material. Examples of the silicon material include silicon or oxides thereof. The silicon material also functions as an active material in the negative electrode for a secondary battery.

The shape of the silicon material configuring the silicon material area 10 may be a particulate form of any shape such as spherical, spindle shaped, squamous shaped, and needle shaped, but a spherical shape is preferable. Superior cycle durability can be obtained by adopting a spherical shape.

The particle size of the silicon material is not particularly limited. Of the particle sizes, in order to obtain even higher cycle durability, the maximum particle size of the silicon material is preferably 1000 nm or less, more preferably 800 nm or less, and even more preferably 700 nm or less.

In addition, the average particle size of the silicon material is preferably 500 nm or less, more preferably 300 nm or less, and even more preferably 200 nm or less.

When the upper limit of the particle size of the silicon material is within the abovementioned range, cracking of the silicon material due to the volume expansion of the silicon material when charging is suppressed, and therefore cycle durability is improved as a result.

The lower limit of the particle size of the silicon material is not particularly limited. For example, the average particle size of the silicon material is preferably 10 nm or greater, and more preferably 30 nm or greater.

Furthermore, the particle size distribution of the silicon material is preferably narrow in order to make the extent of expansion and contraction of the silicon material in each silicon material area 10 uniform. When the particle size distribution of the silicon material is narrow, cracking of overly large silicon material due to the volume expansion of overly large silicon material when charging is suppressed, and as a result, cycle durability can be improved. Furthermore, even if the silicon material undergoes volume expansion due to charging, when the average particle size of the silicon material is 30 nm or greater, the silicon material can suitably contact the carbon material area 20, and can form a conductive network.

When the content amount of the silicon material is large, high specific capacity can be obtained. Therefore, when the amount of the battery negative electrode material 1 is considered to be 100 parts by mass, the lower limit of the content amount of silicon material is preferably 5 mass % or greater, and more preferably 10 mass % or greater, or 15 mass % or greater.

On the other hand, when the content amount of the silicon material is excessive, there is a possibility that the cycle durability could decrease. Therefore, when the amount of the battery negative electrode material 1 is considered to be 100 parts by mass, the upper limit of the content amount of the silicon material is preferably 30 mass % or less, and more preferably 25 mass % or less, 20 mass % or less, or 15 mass % or less. The abovementioned content amount of the silicon material can be measured through inductively coupled plasma (ICP) spectroscopy.

### Carbon Material Area

The carbon material area 20 is configured from a carbon material.

An (002) average interlayer spacing d₀₀₂ of the carbon material area 20 determined by powder X-ray diffraction using CuKα rays is from 0.365 nm to 0.390 nm, and preferably from 0.375 nm to 0.390 nm. When the average interlayer spacing d₀₀₂ is set from 0.365 nm to 0.390 nm, expansion and contraction of the carbon layer in association with lithium doping and de-doping is suppressed, and therefore high cycle characteristics are obtained. In addition, it is thought that contact is maintained between the particles of the silicon material and the particles of the carbon material, thereby making it possible to maintain the conductive network.

In order to obtain higher cycle durability, when the amount of battery negative electrode material 1 is considered to be 100 parts by mass, the lower limit of the content amount of the carbon material is preferably 70 mass % or greater, and more preferably 75 mass % or greater.

Furthermore, in order to obtain a higher specific capacity, when the amount of the battery negative electrode material 1 is considered to be 100 parts by mass, the upper limit of the content amount of carbon material is preferably 95 mass % or less, more preferably 90 mass % or less, and even more preferably 85 mass % or less.

### Cavities

As described above, in a de-doped state (non-charged state) of metal ions such as lithium ions contained in the electrolyte, the silicon material in the silicon material area 10 is contracted, and at least some of the areas between the silicon material areas 10 and the carbon material areas 20 are separated by a cavity 30.

On the other hand, in a doped state (charged state) of the metal ions, the silicon material in the silicon material area 10 expands, and an alloy of lithium and silicon material occupies the cavity.

In a non-doped state, as illustrated in FIG. 1A, when a cross-section is observed with a scanning electron microscope (SEM), a structure is observed for which the silicon material areas 10, the carbon material area 20, and the cavities 30 occupy the cross-section thereof with respective surface areas. The percentage of the surface area of the cavities 30 to the cross-sectional area when a cross section is observed with a scanning electron microscope (SEM) is preferably 2% or greater, and more preferably 4% or greater. By configuring so that the cavities 30 have a size of a certain extent, expansion of the silicon material area 10 in association with doping of metal ions, and destruction of the battery negative electrode material 1 attributed to that expansion can be prevented. In the present specification, the percentage of the surface area that is occupied by the cavities 30 with respect to the cross-sectional area is referred to as the “cavity ratio”.

In the non-doped state, the cavity ratio is preferably 30% or less, and more preferably 20% or less. When the cavities 30 are distributed with a surface area of the abovementioned cavity ratio, the silicon material and the carbon material can suitably contact, and a conductive network can be suitably formed. As a result, an effect of increased specific capacity and improved efficiency is obtained.

### True Density (ρ_{He}) Determined by Helium Displacement Method

The true density (ρ_{He}) measured in accordance with the JIS R1620(4) gas displacement method using helium as a displacement medium is an indicator of helium gas diffusibility. A large ρ_{He} value that is near the theoretical density of carbon of 2.27 g/cm³ means that many pores through which helium can penetrate are present, or in other words, that an abundance of opened pores are present. On the other hand, because helium has a very small atomic diameter (0.26 nm), pores equal to or smaller in size than the helium atom diameter are considered to be closed pores. That is, a low true density (ρ_{He}), which is an indicator of helium gas diffusibility, means that there are many closed pores. From such a perspective, the true density (ρ_{He}) measured using helium gas as the displacement medium can be thought of as a parameter that correlates with the extent of coating formation. Therefore, when a coating is formed on the surface inside the pores, the opened pore diameter becomes smaller, and from the relationship with helium penetration, it is thought that the state approaches a state of numerous closed pores, and thus a relatively low numeric value is expressed for the true density (ρ_{He}).

According to the above description, a true density (ρ_{Hc}) of 1.90 g/cm³ or less suggests that a carbon coating is formed on the surfaces of the silicon material areas 10 and the carbon material area 20. The surface area that contacts the electrolyte solution can be controlled by forming the abovementioned carbon coating on the surfaces of the silicon material areas 10 and carbon material area 20. When the surface area thereof is reduced by the formation of the carbon coating, the irreversible capacity can be reduced. Furthermore, by reducing the irreversible capacity, the charge/discharge efficiency can be improved. Therefore, the upper limit of the true density (ρ_{He}) is preferably 1.90 g/cm³ or less, more preferably 1.85 g/cm³ or less, and even more preferably 1.80 g/cm³ or less.

The lower limit of the true density (ρ_{He}) is not particularly limited, but when the true density is excessively small, sufficient charge/discharge capacity cannot be obtained, and therefore the true density (ρ_{He}) is preferably 1.30 g/cm³ or greater, more preferably 1.35 g/cm³ or greater, and even more preferably 1.40 g/cm³ or greater.

### Atom Ratio (H/C) of Hydrogen Atoms to Carbon Atoms

The H/C ratio was determined by measuring hydrogen atoms and carbon atoms through elemental analysis. Since the hydrogen content of the carbonaceous material decreases as the degree of carbonization increases, the H/C ratio tends to decrease. Accordingly, the H/C ratio is effective as an index expressing the degree of carbonization. The H/C ratio of the carbonaceous material of the present invention is at most 0.1 and preferably at most 0.08. The H/C ratio is particularly preferably not greater than 0.05. When the H/C ratio of hydrogen atoms to carbon atoms exceeds 0.1, the amount of functional groups present in the carbonaceous material increases, and the irreversible capacity increases due to a reaction with lithium.

### 2. Method for Manufacturing Battery negative Electrode Material

The present manufacturing method includes at least the following steps (a) to (c).

Step (a): Melting and mixing or dissolving and mixing with an organic material composition, a coated silicon material (Si/SiO₂) that has been coated with silicon oxide to obtain a mixture containing a coated silicon material area 10′ of the coated silicon material, and an organic material area 20′ of the organic material composition.

Step (b): Removing the silicon oxide from the coated silicon material area 10′ to convert the coated silicon material area 10′ to a silicon material area 10.

Step (c): Carbonizing the organic material constituting the organic material area 20′ to obtain the carbon material area 20.

Note that the order of steps (b) and (c) is not particularly limited. Step (b) may be performed before step (c) is performed, or step (c) may be performed before step (b) is performed.

### Step (a): Mixing Coating Silicon Material with an Organic Material Composition

In step (a), a coated silicon material (Si/SiO₂) that has been coated with silicon oxide is melted and mixed or dissolved and mixed with an organic material composition.

### Coated Silicon Material

The coated silicon material (Si/SiO₂) is obtained by coating silicon oxide (SiO₂) onto the surface of silicon precursor (Si) by heat treating a silicon material precursor in an air atmosphere, oxygen, or a mixed gas atmosphere containing oxygen. Nano silicon particles and the like can be used as the silicon material precursor.

As described above, the maximum particle size of the silicon material configuring the silicon material area 10 is 1000 nm or less, which is a nano size level. In addition, the particle size distribution of the silicon material is preferably narrow.

The coating layer of the coated silicon material is removed in step (b), and a cavity is formed between the carbon material area and the silicon material. The cavity needs to secure sufficient volume for alleviating expansion during charging. In order to form a silicon oxide layer of a certain thickness or greater, the lower limit of the heat treatment temperature when producing the coated silicon material is preferably 500° C. or higher, more preferably 600° C. or higher, and even more preferably 700° C. or higher. However, in a case where the silicon oxide layer becomes too thick, the percentage of the cavities obtained in step (b) becomes excessive, and the percentage occupied by the silicon material areas and the carbon material area decreases. Therefore, the upper limit of the heat treatment temperature is preferably 1100° C. or lower, more preferably 1000° C. or lower, and even more preferably 900° C. or lower.

### Organic Material Composition

The organic material composition is not particularly limited, and for example, petroleum-based pitch or tar, coal-based pitch or tar, thermoplastic resins, or thermosetting resins can be used. A petroleum-based pitch or tar is preferable. Specific examples of petroleum or coal tar or pitch that can be used include petroleum tar or pitch produced as a by-product at the time of ethylene production, coal tar produced at the time of coal destructive distillation, heavy components or pitch from which the low-boiling-point components of coal tar are distilled out, or tar or pitch obtained by coal liquefaction. Two or more of these types of tar and pitch may also be mixed together. Additional examples include pitch that has been crosslinked or thermally treated to be made heavier, the pitch being obtained by subjecting a petroleum-based or coal-based tar or pitch to a crosslinking treatment or a thermal heavy substance treatment. Use of a petroleum-based or coal-based tar or pitch enables an increase in the shape stability of the battery negative electrode material 1 after the organic material composition has been carbonized by step (c).

The thermosetting resins are not particularly limited, and examples include novolac phenolic resins, resol phenolic resins, and other such phenolic resins, bisphenol type epoxy resins, novolac epoxy resins, and other such epoxy resins, melamine resins, urea resins, aniline resins, cyanate resins, furan resins, ketone resins, unsaturated polyester resins, and urethane resins. In addition, modified substances obtained by modifying these with various components can also be used.

Furthermore, the thermoplastic resins are also not particularly limited, and examples include polyethylene, polystyrene, polyacrylonitrile, acrylonitrile-styrene (AS) resin, acrylonitrile-butadiene-styrene (ABS) resin, polypropylene, vinyl chloride, methacrylic resin, polyethylene terephthalate, polyamide, polycarbonate, polyacetal, polyphenylene ether, polybutylene terephthalate, polyphenylene sulfide, polysulfone, polyethersulfone, polyether ether ketone, polyether imide, polyamide imide, polyimide, and polythalamide.

### Mixing

The mixing of the coated silicon material (Si/SiO₂) with the organic material composition is performed by melting and mixing or dissolving and mixing. After the materials are mixed while heating, the mixture is cooled, and a composite substance for which the coated silicon material is dispersed in the organic material composition can be obtained.

When mixing, the organic material composition may be in a state of being dispersed in a solvent. The solvent is not particularly limited as long as it can dissolve the organic material composition. Examples of the solvent include toluene, acetone, methyl ethyl ketone, and other such ketones, diethyl ether, ethylene glycol monomethyl ether, and other such ethers, methanol, ethanol, propanol, and other alcohols, dimethylformamide and other amides.

The mixing in step (a) is for favorably stirring and dispersing the mixed materials. For cases in which melting and mixing are performed, a kneading device such as, for example, kneading rollers, or a single screw or twin screw kneader can be used. Furthermore, for cases in which dissolving and mixing are performed, a mixing device such as, for example, a Henschel mixer or disperser can be used.

### Pulverization

The composite substance of the coated silicon material (Si/SiO₂) and organic material composition is subjected to a prescribed treatment in the below-described step (b) or step (c). To facilitate the effective progression of the treatment, the abovementioned composite substance is preferably pulverized to create a powder form. The pulverizer used for pulverization is not particularly limited, and a jet mill, a rod mill, or a ball mill, for example, can be used. For cases in which the generation of fine powder is to be suppressed, a jet mill provided with a classification function is preferable. On the other hand, in cases where using a ball mill, a rod mill, or the like, fine powder can be removed by performing classification after pulverizing.

Examples of classification when classification is performed include classification with a sieve, wet classification, and dry classification. An example of a wet classifier is a classifier utilizing a principle such as gravitational classification, inertial classification, hydraulic classification, or centrifugal classification. An example of a dry classifier is a classifier utilizing a principle such as sedimentation classification, mechanical classification, or centrifugal classification.

### Infusibilization

The composite substance of the coated silicon material and organic material composition is subjected to an infusibilization treatment, and an infusibilized carbon precursor that is infusible with respect to heat is formed. The method used for infusibilization treatment is not particularly limited, but the infusibilization treatment may be performed using an oxidizer or a crosslinking agent, for example. The oxidizer is also not particularly limited, but O₂, O₃, SO₃, NO₂, a mixed gas in which these are diluted with air, nitrogen, or the like, or air or other such oxidizing gases, or a mixed gas in which these oxidizing gases are diluted with nitrogen, carbon dioxide, water vapor, or other such inert gases may be used as a gas. In addition, an oxidizing liquid such as sulfuric acid, nitric acid, or hydrogen peroxide or a mixture thereof can be used as a liquid. As a crosslinking agent, for example, a polyfunctional vinyl monomer with which crosslinking reactions are promoted by radical reactions can be used, examples thereof including divinylbenzene, trivinylbenzene, diallyl phthalate, ethylene glycol dimethacrylate, or N,N-methylene bis-acrylamide. Crosslinking reactions caused by the polyfunctional vinyl monomer are initiated by adding a radical initiator. Here, α,α′-azobis-isobutyronitrile (AIBN), benzoyl peroxide (BPO), lauroyl peroxide, cumene hydroperoxide, 1-butyl hydroperoxide, hydrogen peroxide, or the like can be used as a radical initiator. The oxidation temperature is also not particularly limited but is preferably from 100 to 400° C., more preferably from 150 to 350° C., and even more preferably from 130 to 300° C. When the temperature is lower than 100° C., a crosslinked structure cannot be formed sufficiently, and particles fuse to one another in the heat treatment step. When the temperature exceeds 400° C., decomposition reactions become more prominent than crosslinking reactions, and the yield of the resulting carbon material becomes low.

### Step (b): Silicon Oxide Removal

In step (b), silicon oxide is removed from the coated silicon material area 10′ to convert the coated silicon material area 10′ to the silicon material area 10.

The means for removing the silicon oxide is not particularly limited. An example of a removal method is one in which a treatment agent such as an aqueous solution of hydrofluoric acid is used to dissolve the silicon oxide on the surface of the coated silicon material area 10′. The treatment agent passes through the organic material area 20′ or the carbon material area 20, contacts the surface of the coated silicon material area 10′, and dissolves the silicon oxide. Examples of the treatment material that can be used to remove the silicon oxide include hydrofluoric acid, sodium hydroxide, and other such liquid treatment agents, and hydrogen fluoride gas and other such treatment agents in gas form.

When the silicon material configuring the silicon material area 10 oxidizes, the material becomes silicon dioxide, and causes a decrease in the function as a battery negative electrode material 1. Therefore, in order to prevent oxidation of the surface of the silicon material area 10, preferably dissolved oxygen contained in the hydrofluoric acid solution is removed and a treatment to suppress photo-oxidation of the silicon material is performed.

### Step (c): Carbonizing of Organic Material

In step (c), with regard to the carbon precursor, the organic material constituting the organic material composition is carbonized to obtain the carbon material area 20.

The carbonizing conditions are not particularly limited. The carbon precursor having the organic material is preferably fired in an inert atmosphere (such as, for example, helium or nitrogen gas). Through this, the matter of carbon atoms configuring the organic material being removed as carbon dioxide or the like beyond the necessary level can be prevented, thereby resulting in an excellent yield of residual carbon. Firing may include conducting a preliminary firing followed by a main firing, or conducting only a main firing. When performing preliminary firing and main firing, the carbon precursor may be pulverized and subjected to main firing after the temperature is reduced after preliminary firing.

### Preliminary Firing

The preliminary firing is performed by firing the carbon precursor at 350° C. or higher but lower than 800° C. The preliminary firing removes, for example, volatile matter such as CO₂, CO, CH₄, and H₂, and tar content so that the generation of these components can be reduced and the burden of the firing vessel can be reduced in main firing. When the preliminary firing temperature is lower than 350° C., de-tarring becomes insufficient, and the amount of tar components or gas generated in the main firing step becomes large. There is a possibility that these may adhere to the particle surface and cause a decrease in battery performance without the surface properties being maintained after pulverization, which is not preferable. The lower limit of the preliminary firing temperature is preferably at least 350° C., more preferably at least 400° C., and particularly preferably at least 600° C.

On the other hand, when the preliminary firing temperature is 800° C. or higher, the temperature exceeds the tar-generating temperature range, and the efficiency of the energy that is used decreases, which is not preferable. Furthermore, the generated tars cause a secondary decomposition reaction, adhere to the carbon precursor, and cause a decrease in performance, which is not preferable. Additionally, when the preliminary firing temperature is too high, carbonization progresses and the particles of the carbon precursor become too hard. As a result, when pulverization is performed after the preliminary firing, pulverization may be difficult due to the chipping away of the interior of the pulverizer, which is not preferable.

The preliminary firing is performed in an inert gas atmosphere, and examples of the inert gas include nitrogen, argon, and the like. In addition, the preliminary firing can be performed under reduced pressure at a pressure of 10 kPa or lower, for example. The preliminary firing time is also not particularly limited, and for example, preliminary firing can be performed for 0.5 to 10 hours, and preferably for 1 to 5 hours.

### Main Firing

The main firing can be performed in accordance with an ordinary main firing procedure, and a carbonaceous material can be obtained by performing the main firing. The temperature of main firing is preferably from 800 to 1500° C. In order to facilitate the advancement of carbonization of the organic material configuring the organic material composition, the lower limit of the main firing temperature is preferably 800° C. or higher, more preferably 900° C. or higher, and even more preferably 1000° C. or higher. In a case where the main firing temperature is lower than 800° C., a large amount of functional groups remain in the carbonaceous material, the value of the H/C atom ratio increases, and the irreversible capacity also increases due to a reaction with lithium. Therefore, such a main firing temperature is not preferable.

On the other hand, in order to prevent the generation of silicon carbide through a reaction between carbon and silicon, the upper limit of the main firing temperature is preferably 1500° C. or lower, more preferably 1400° C. or lower, and even more preferably 1300° C. or lower. Silicon carbide is not electrically conductive, does not react with lithium ions, and cannot exhibit capacitance. Therefore, the specific capacity decreases as the amount of silicon carbide that is generated increases. When the main firing temperature is set to 1500° C. or lower, the generation of silicon carbide can be suppressed, and the specific capacity of the battery negative electrode material can be increased.

The main firing is preferably performed in a non-oxidizing gas atmosphere. Examples of non-oxidizing gases include helium, nitrogen, and argon, and the like, and these may be used alone or as a mixture. The main firing may also be performed in a gas atmosphere in which a halogen gas such as chlorine is mixed with the non-oxidizing gas described above. Furthermore, the main firing can be performed under reduced pressure at a pressure of not higher than 10 kPa, for example. The main firing time is not particularly limited, and for example, the main firing can be performed for 0.05 to 10 hours, preferably for 0.05 to 8 hours, and more preferably for 0.05 to 6 hours. The upper limit of the main firing time is more preferably 3 hours, and most preferably 1 hour.

The order of steps (b) and (c) is not particularly limited. Step (b) may be performed first, and then subsequently step (c) may be performed, or step (c) may be performed first, and then subsequently step (b) may be performed.

The ease of permeation through the organic material area 20′ or the carbon material area 20 by the treatment agent such as an aqueous solution of hydrofluoric acid is affected by the extent of carbonization (degree of carbonization) of the organic material configuring the organic material area 20′ or the carbon material area 20. The carbonaceous material obtained with the main firing of step (c) is provided with a compact carbonaceous structure. Depending on the type and properties of the treatment agent for silicon oxide removal, in some cases it may be difficult to permeate a highly compact carbonaceous structure. When this is the case, preferably, step (b) is performed before step (c).

Furthermore, with a carbon precursor subjected to preliminary firing at lower than 800° C., carbonization does not fully advance, and the carbonaceous structure thereof does not exhibit thorough compactness. In such a case, the treatment agent for silicon oxide removal can effectively permeate the carbonaceous structure having a low degree of compactness. After the preliminary firing is performed, step (b) may be performed, and subsequently, the main firing of step (c) may be performed.

### Step (d): Carbon Coating Formation

While not essential, in order to prevent the irreversible capacity from becoming large, preferably, a carbon coating is formed on the surface of the silicon material areas 10 and the carbon material area 20 to suppress the surface area of contact between the battery negative electrode material 1 and the electrolyte solution. The surface area of the carbon material area that contacts the electrolyte solution can be controlled by forming the carbon coating.

The coating step coats the abovementioned fired battery negative electrode material with a pyrolytic carbon. Coating with a pyrolytic carbon may be performed using the CVD method. More specifically, the battery negative electrode material is made to contact a straight-chain or cyclic hydrocarbon gas, and carbon that has been purified by pyrolysis is vapor-deposited onto the battery negative electrode material. This method is well known as the so-called chemical vapor deposition method (CVD method).

The number of carbon atoms of the hydrocarbon gas is not limited but is preferably from 1 to 25, more preferably from 1 to 20, even more preferably from 1 to 15, and most preferably from 1 to 10.

The carbon source of the hydrocarbon gas is also not limited, and examples include methane, ethane, propane, butane, pentane, hexane, octane, nonane, decane, ethylene, propylene, butene, pentene, hexene, acetylene, cyclopentane, cyclohexane, cycloheptane, cyclooctane, cyclononane, cyclopropene, cyclopentene, cyclohexene, cycloheptene, cyclooctene, decalin, norbornene, methylcyclohexane, norbornadiene, benzene, toluene, xylene, mesitylene, cumene, butylbenzene, and styrene. In addition, a hydrocarbon gas produced by heating a gaseous organic substance and a solid or liquid organic substance may also be used as a carbon source for the hydrocarbon gas.

### 3. Negative Electrode for Secondary Battery

The battery negative electrode material according to the present embodiment is used as a negative electrode for a secondary battery, and in particular, is suitably used as a member for a negative electrode of a non-aqueous electrolyte secondary battery. The secondary battery negative electrode can be manufactured, for example, in the following manner.

A negative electrode of the present invention that uses a carbonaceous material can be manufactured by adding a binding agent (binder) to the carbonaceous material, adding an appropriate amount of a suitable solvent, kneading to form an electrode mixture, and subsequently, coating the electrode mixture onto a current collector formed from a metal plate or the like and drying, and then pressure-molding.

### Conductive Additive

When preparing the electrode mixture, a conductive additive can be added as necessary for the purpose of imparting high electric conductivity. Examples of conductive additives that can be used include acetylene black, Ketjen black, carbon nanofibers, carbon nanotubes, and carbon fibers.

The added amount of the conductive additive differs depending on the type of the conductive additive that is used, but when the added amount is too small, the expected conductivity cannot be achieved, which is not preferable. Conversely, when the added amount is too large, the dispersion of the conductive additive in the electrode mixture becomes poor, which is not preferable. From this perspective, the percentage of the added amount of the conductive additive is preferably from 0.5 to 15 wt. % (here, it is assumed that the amount of the active material (carbonaceous material)+the amount of the binder+the amount of the conductive additive=100 wt. %), more preferably from 0.5 to 13 wt. %, and particularly preferably from 0.5 to 10 wt. %.

### Binder

The binder is not particularly limited as long as the binder does not react with the electrolyte solution. Examples of the binder include polyvinylidene fluoride (PVDF), polytetrafluoroethylene, polyimide, and a mixture of styrene-butadiene rubber (SBR) and carboxymethyl cellulose (CMC). In order to form a slurry by dissolving PVDF, a polar solvent such as N-methylpyrrolidone (NMP) can be preferably used; however, an aqueous emulsion such as SBR, or CMC can be also used by dissolving in water.

When the added amount of the binder is too large, since the resistance of the resulting electrode becomes large, the internal resistance of the battery becomes large. This diminishes the battery characteristics, which is not preferable. When the added amount of the binder is too small, the bonds between the negative electrode material particles, and the bonds between with the current collector become insufficient, which is not preferable. The preferable amount of the binder that is added differs depending on the type of the binder that is used; however, when a PVDF-based binder is used, the amount of binder is preferably from 1 to 13 wt. %, and more preferably from 3 to 10 wt. %. On the other hand, in the case of a binder using water as a solvent, a plurality of binders such as a mixture of SBR and CMC is often mixed and used, and the total amount of all of the binders that are used is preferably from 0.5 to 7 wt. % and more preferably from 1 to 5 wt. %.

### Electrode Active Material Layer

The electrode active material layer is typically formed on both sides of the current collector, but the layer may be formed on one side as necessary. The number of required current collectors or separators becomes smaller as the thickness of the electrode active material layer increases, which is preferable for increasing capacity. However, as the electrode surface area facing a counter electrode becomes wider, the input/output characteristics advantageously improve, and therefore, when the active material layer is too thick, the input/output characteristics are diminished, which is not preferable.

### Negative Electrode Current Collector

The negative electrode ordinarily has a current collector. Steel use stainless (SUS), copper, nickel, or carbon, for example, can be used as a negative electrode current collector, but of these, copper or SUS is preferable.

### 4. Secondary Battery

The secondary battery is configured containing the above-described secondary battery negative electrode, as well as a secondary battery positive electrode, and an electrolyte solution that fills the space between the negative electrode and positive electrode of the secondary battery.

### Positive Electrode for Secondary Battery

The positive electrode contains a positive electrode active material and may further contain a conductive additive and/or a binder. The mixing ratio of the positive electrode active material and other materials in the positive electrode active material layer is not limited and may be determined appropriately as long as the effect of the present invention can be achieved.

The positive electrode material can be used without limiting the positive electrode active material. Examples include layered oxide-based complex metal chalcogen compounds (as represented by LiMO₂, where M is a metal such as LiCoO₂, LiNiO₂, LiMnO₂, or LiNiₓCo_{y}Mn_{z}O₂ (where x, y, and z represent composition ratios)), olivine-based complex metal chalcogen compounds (as represented by LiMPO₄, where M is a metal such as LiFePO₄), and spinel-based complex metal chalcogen compounds (as represented by LiM₂O₄, where M is a metal such as LiMn₂O₄ for example), and these chalcogen compounds may be mixed as necessary.

In addition, ternary [Li(Ni—Mn—Co)O₂] materials in which the material stability is enhanced by replacing some of the cobalt of lithium cobaltate with nickel and manganese and using the three components of cobalt, nickel, and manganese, and NCA-based materials [Li(Ni—Co—Al)O₂] in which aluminum is used instead of manganese in the ternary materials described above, are known, and these materials may be used.

The positive electrode may further contain a conductive additive and/or a binder. Examples of conductive additives include acetylene black, Ketjen black, and carbon fibers. The content of the conductive additive is not limited but may be from 0.5 to 15 wt. %, for example. As the binder, examples include fluorine-containing binders such as PTFE or PVDF. The content of the binder is not limited but may be from 0.5 to 15 wt. %, for example.

The positive electrode active material layer ordinarily has a current collector. SUS, aluminum, nickel, iron, titanium, and carbon, for example, can be used as a cathode current collector, and of these, aluminum or SUS is preferable.

### Electrolyte Solution

A non-aqueous solvent electrolyte solution used with this positive electrode and negative electrode combination is typically formed by dissolving an electrolyte in a non-aqueous solvent. One type or two or more types of organic solvents such as propylene carbonate, ethylene carbonate, dimethyl carbonate, diethyl carbonate, dimethoxyethane, diethoxyethane, γ-butyl lactone, tetrahydrofuran, 2-methyl tetrahydrofuran, sulfolane, or 1,3-dioxolane, for example, may be used in combination as a non-aqueous solvent. Furthermore, LiClO₄, LiPF₆, LiBF₄, LiCF₃SO₃, LiAsF₆, LiCl, LiBr, LiB(C₆H₅)₄, LiN(SO₃CF₃)₂ and the like can be used as the electrolyte. The secondary battery is typically formed by arranging a positive electrode layer and a negative electrode layer, which are produced as described above, in a manner facing each other with a liquid permeable separator, which is formed from a nonwoven fabric or other porous material, interposed therebetween, and then immersing in an electrolyte solution. As a separator, a liquid permeable separator that is formed from nonwoven fabric and other porous materials and is typically used in secondary batteries can be used. Alternatively, in place of a separator or together with a separator, a solid electrolyte formed from polymer gel in which an electrolyte solution is impregnated can be also used.

### Solid Electrolyte

The solid electrolyte material that can be used is not limited to a material used in the field of lithium-ion secondary batteries, and a solid electrolyte material including an organic compound, an inorganic compound, or a mixture thereof may be used. The solid electrolyte material has ionic conductivity and insulating properties. A specific example is a polymer electrolyte (for example, a true polymer electrolyte), a sulfide solid electrolyte material, or an oxide solid electrolyte material, but a sulfide solid electrolyte material is preferable.

Examples of true polymer electrolytes include polymers having ethylene oxide bonds, crosslinked products thereof, copolymers thereof, and polyacrylonitrile- and polycarbonate-based polymers, examples of which include polyethylene oxide, polyethylene carbonate, and polypropylene carbonate.

Examples of sulfide solid electrolyte materials include Li₂S, Al₂S₃, SiS₂, GeS₂, P₂S₃, P₂S₅, As₂S₃, Sb₂S₃, and mixtures and combinations thereof. That is, examples of sulfide solid electrolyte materials include Li₂S—Al₂S₃ materials, Li₂S—SiS₂ materials, Li₂S—GeS₂ materials, Li₂S—P₂S₃ materials, Li₂S—P₂S₅ materials, Li₂S—As₂S₃ materials, Li₂S—Sb₂S₃ materials, and Li₂S materials, and Li₂S—P₂S₅ materials are particularly preferable. Further, Li₃PO₄, halogens, or halogenated compounds may be added to these solid electrolyte materials and used as solid electrolyte materials.

Examples of oxide solid electrolyte materials include oxide solid electrolyte materials having a perovskite-type, NAS ICON-type, or garnet-type structure, examples of which include La_{0.51}LiTiO_{2.94}, Li_{1.3}Al_{0.3}Ti_{1.7}(PO₄)₃, Li₇La₃Zr₂O₁₂, and the like.

Examples of additives include, but are not limited to, fluoroethylene carbonate (FEC), trimethyl silyl phosphoric acid (TMSP), chloroethylene carbonate (ClEC), propanesultone (PS), ethylene sulfite (ES), vinylene carbonate (VC), vinyl ethylene carbonate (VEC), and dioxathiolane dioxide (DTD).

The separator is not particularly limited, and for example, polyethylene, polypropylene and other such porous films, and nonwoven fabrics can be used.

Furthermore, the secondary battery can be manufactured using a known method for manufacturing secondary batteries.

### EXAMPLES

The present invention is explained in greater detail below through the use of examples. However, the present invention is not limited by the following examples.

The methods for measuring the physical property values (Si content, maximum particle size of the silicon material, d₀₀₂, cavity ratio, true density (ρ_{He}), H/C, charge capacity, discharge capacity, irreversible capacity, discharge efficiency, and capacity retention rate) of the battery negative electrode material according to the present invention are described below. The values of the physical properties described in this specification, including those in the examples, are based on values determined by the following methods.

### (0002) Average Interlayer Spacing d₀₀₂ of the Carbon Material Area

A sample holder was filled with a carbonaceous material powder, and measurements were taken with a symmetrical reflection method using an X'Pert PRO available from PANalytical B.V. Under conditions with a scanning range of 8<2θ<50° and an applied current/applied voltage of 45 kV/40 mA, an X-ray diffraction pattern was obtained using CuKα rays (k=1.5418 Å) monochromatized by an Ni filter. A correction was performed by using the diffraction peak of the (111) surface of a high-purity silicon powder serving as a standard substance. The wavelength of the CuKα rays was set to 0.15418 nm, and d₀₀₂ was calculated by the Bragg's equation presented below.

$$\begin{matrix}[ Equation 1 ] & \\ {d}_{002} = \frac{λ}{2 \cdot sin θ} & ( Bragg ' s equation )\end{matrix}$$

λ: Wavelength of X-rays; θ: Diffraction angle

### Percentage of Surface Area of Cavities with Respect to the Cross-Sectional Area (Cavity Ratio)

In a non-doped state, a percentage of the surface area of the cavities with respect to a cross-sectional area when a cross-section was observed at a magnification of 100,000 times with a scanning electron microscope (SEM) was measured. More specifically, the surface area percentage of the cavity portion obtained by binarization processing using “Azo-kun” (from Asahi Kasei Engineering Corporation) was used as the cavity ratio. As the setting conditions for particle analysis, for example, the brightness was set to “light”, the binarization method was set to “automatic”, the small figure removal surface area was set to 0.1 nm, and a threshold value that is an indicator of the lightness or darkness of an image was set from 10 to 500. Two arbitrary locations were selected in the cross-section, and an average value of the obtained cavity ratio was used. Furthermore, for cases in which the brightness difference between the carbon portion and the cavity portion is small, and the cavity portion cannot be clearly recognized, the abovementioned image processing may be performed after changing the color of the cavity portions using Photoshop or other such software.

### True Density (ρ_{He}) Determined by the Helium Method

The dry automatic pycnometer AccuPycII1340 (available from Shimadzu Corporation) was used to measure the ρ_{He}. Measurement was performed after drying samples in advance at 200° C. for 5 hours or longer. A 10 cm³ cell was used and a 1 g sample was placed therein. Measurements were performed at an ambient temperature of 23° C. Purging was performed 10 times, and an average value obtained from five purges (n=5) when it was confirmed that the volume values obtained by repeated measurements were identical within a deviation of 0.5%, was used as the ρ_{He}.

The measurement device was equipped with a sample chamber and an expansion chamber, and the sample chamber had a pressure gauge for measuring the pressure inside the chamber. The sample chamber and the expansion chamber were connected by a connection tube having a valve. A helium gas introduction tube having a stop valve was connected to the sample chamber, and a helium gas discharging tube having a stop valve was connected to the expansion chamber.

More specifically, measurements were performed as described below.

The volume of the sample chamber (V_{CELL}) and the volume of the expansion chamber (V_{EXP}) were measured in advance using calibration spheres of a known volume. A sample was placed in the sample chamber, and then the system was filled with helium and the pressure in the system at that time was denoted as Pₐ. Next, the valve was closed, and helium gas was introduced only to the sample chamber to increase the pressure thereof to a pressure P₁. Subsequently, the valve was opened to connect the expansion chamber and the sample chamber, and the pressure within the system decreased to a pressure P₂ due to expansion.

The volume of the sample (V_{SAMP}) at that time was calculated by the following formula.

V_{SAMP}=V_{CELL}−[V_{EXP}/{(P₁−Pₐ)/(P₂−Pₐ)−1}] [Equation 2]

Accordingly, when the mass of the sample is considered to be WSAMP, the density can be calculated using the following equation.

ρ_{HE}=W_{SAMP}/V_{SAMP} [Equation 3]

### Si Content

The Si content amount of the battery negative electrode material can be measured through inductively coupled plasma (ICP) spectroscopy. Ten milligrams of the sample was ashed at 700° C. for one hour, and then mixed with 0.3 g of a flux and melted at 1000° C., after which 3 mL of nitric acid was added to dissolve the material. The mixture was then diluted to 100 mL, and measured with ICP-Atomic Emission Spectrometry (ICP-AES).

### Atom Ratio (H/C) of Hydrogen Atoms to Carbon Atoms

The atom ratio H/C was measured in accordance with the method stipulated in JIS M8819. The ratio of the numbers of hydrogen/carbon atoms was determined from the mass ratio of hydrogen and carbon in the sample obtained by elemental analysis using a CHN analyzer.

### Maximum Particle Size of Silicon Material

When the cavity ratio is measured through cross-sectional observation using a scanning electron microscope (SEM), the maximum particle size of the silicon material in that observation area can be measured. In the present specification, the presence or lack of silicon material particles having a particle size of 1000 nm or greater was confirmed.

### Doping/De-Doping Test of Active Material

Battery negative electrode materials 1 to 6 and comparative battery negative electrode materials 1 to 8 obtained in the examples and comparative examples were used, and negative electrodes and non-aqueous electrolyte secondary batteries were produced by performing the following operations (i) to (iii), and the electrode performance thereof was evaluated.

### (i) Production of Electrodes

A negative electrode mixture was prepared by adding water to 85 parts by mass of the abovementioned battery negative electrode material, 3 parts by mass of SBR, 2 parts by mass of CMC, and 10 parts by mass of carbon black to form a paste. The electrode mixture was spread uniformly on copper foil. After the sample was dried, the sample was punched from the copper foil into a disc shape with a diameter of 15 mm, and pressed to obtain an electrode. The amount of the battery negative electrode material in the electrode was adjusted to approximately 10 mg.

### (ii) Production of Test Battery

Although the battery negative electrode material of the present invention is suitable for forming a negative electrode for a non-aqueous electrolyte secondary battery, in order to precisely evaluate the discharge capacity (de-doping amount) and the irreversible capacity (non-de-doping amount) of the battery active material without being affected by fluctuations in the performance of the counter electrode, a lithium secondary battery was formed using the electrode obtained above together with a counter electrode made of lithium metal with stable characteristics, and the characteristics thereof were evaluated.

The lithium electrode was prepared inside a glove box in an Ar atmosphere. An electrode (counter electrode) was formed by spot-welding a stainless steel mesh disc with a diameter of 16 mm onto the outer lid of a 2016-size coin-type battery can in advance, and subsequently punching a thin sheet of metal lithium with a thickness of 0.8 mm into a disc shape with a diameter of 15 mm, and pressing the thin sheet of metal lithium into the stainless steel mesh disc.

A 2016-size coin-type non-aqueous electrolyte lithium secondary battery was assembled in an Ar glove box by using a pair of electrodes produced in this way, using a solution in which LiPF₆ was added at a proportion of FEC 1.0 wt. % and 1.4 mol/L to a mixed solvent prepared by mixing ethylene carbonate, dimethyl carbonate, and methyl ethyl carbonate at a volume ratio of 1:2:2 as an electrolyte solution, using a fine porous membrane made of borosilicate glass fibers with a diameter of 19 mm as a separator, and using a polyethylene gasket.

### (iii) Measurement of Battery Capacity

Charge-discharge tests were performed at 25° C. on a lithium secondary battery with the configuration described above using a charge-discharge tester (“TOSCAT” available from Toyo System Co., Ltd.). A lithium doping reaction for doping lithium into the carbon electrode was performed with a constant-current/constant-voltage method, and a de-doping reaction was performed by a constant-current method. Here, with a battery that uses a lithium chalcogen compound for the positive electrode, the doping reaction for doping lithium into the carbon electrode is called “charging”, and with a battery that uses lithium metal for a counter electrode as in the test battery of the present invention, the doping reaction for doping into the carbon electrode is called “discharging”. Thus, the naming of the doping reactions for doping lithium into the same carbon electrode differs depending on counter electrode that is used. Therefore, the doping reaction for inserting lithium into the carbon electrode will be described as “charging” hereafter for the sake of convenience. Conversely, “discharging” refers to a charging reaction in the test battery but is described as “discharging” for the sake of convenience since it is a de-doping reaction for removing lithium from the carbonaceous material.

The charging method used here was a constant-current/constant-voltage method. More specifically, constant-current charging was performed at 0.5 mA/cm² until the terminal voltage reached 0.0 V. After the terminal voltage reached 0.0 V, constant-voltage charging was performed at a terminal voltage of 0.0 V, and charging was continued until the current value reached 20 gA. At this time, a value determined by dividing the amount of supplied electricity by the mass of the battery negative electrode material of the electrode is defined as the charge capacity per unit mass (mAh/g) of the battery negative electrode material.

After the completion of charging, the battery circuit was opened for 30 minutes, and discharging was performed thereafter. Discharging was performed at a constant current of 0.5 mA/cm² until the termination voltage reached 1.5 V. At this time, a value determined by dividing the amount of discharged electricity by the mass of the carbonaceous material of the electrode is defined as the discharge capacity per unit mass (mAh/g) of the battery negative electrode material. The irreversible capacity was calculated as the discharge capacity subtracted from the charge capacity. The charge/discharge capacities and irreversible capacity were determined by averaging three measurements (n=3) for test batteries produced using the same sample.

Additionally, a value obtained by dividing the discharge capacity by the charge capacity was multiplied by 100 to determine the discharge efficiency (%). This discharge efficiency is a value that indicates how effectively the active material was used.

### (iv) Measurement of Capacity Retention Rate (Cycle Tests)

Charging and discharging were repeatedly performed with the same charging and discharging conditions using the lithium secondary battery of the abovementioned configuration. Additionally, a value obtained by dividing the discharge capacity of the tenth time by the discharge capacity of the first time was multiplied by 100 to calculate the capacity retention rate (%).

Furthermore, after the battery was charged to a fully charged state under the abovementioned charging and discharging conditions, the battery was disassembled in the glove box. The thickness of the electrode that was disassembled and removed was measured with a thickness gauge (from Mitutoyo), and a value obtained by dividing a thickness (B) after charging by a thickness (A) before charging was multiplied by 100 to calculate the expansion rate (%).

### Example 1

Silicon particles having a silicon oxide film (Si/SiO₂) were prepared by heat treating nano silicon (from EM Japan) having an average particle size of 60 nm in an air atmosphere at 800° C. for 9 hours. Next, petroleum pitch having a softening point of 200° C. and an H/C atom ratio of 0.65 was mixed with the abovementioned coated silicon particles (Si/SiO₂) having a silicon oxide film. After the mixture was stirred while heating at 300° C., the mixture was cooled to room temperature, and thereby a composite pitch material in which silicon particles (Si/SiO₂) were dispersed was prepared. The obtained composite pitch was coarsely pulverized using a hammer mill, and then subsequently pulverized using a jet mill (100-AFG from Hosokawa Micron Corporation) until the average particle size was 13 μm, and a finely pulverized composite pitch was obtained.

Next, the finely pulverized composite pitch was subjected to an infusibilization treatment by heating in an air atmosphere to a temperature of 260° C., and then maintaining at 260° C. for one hour. The obtained infusible finely pulverized composite pitch was inserted into a container containing a 5 mass % hydrofluoric acid aqueous solution, and then stirred for 60 minutes in a dark room at room temperature in an argon gas atmosphere to thereby remove the silicon oxide from the coated silicon material area 10′.

Subsequently, the material was then heat treated in a nitrogen gas atmosphere at 600° C. for one hour. This heat treatment corresponds to the preliminary firing treatment for removal of the volatile portion and tar portion.

Next, 5 g of the finely pulverized composite pitch that had been heat treated as described above was inserted into a horizontal tubular furnace with a diameter of 100 mm and heated to 1100° C. at a temperature increasing rate of 250° C./h, after which the material was maintained for one hour at 1100° C. and subjected to a main firing. Note that the main firing was performed in a nitrogen atmosphere with a flow rate of 10 L/min. Through this, a battery negative electrode material containing the silicon material areas 10, the carbon material area 20 in a carbonized state, and the cavities 30 was obtained.

Next, 3 g of the obtained battery negative electrode material was placed in a quartz reaction tube and heated and held at 780° C. under a nitrogen gas air flow. The negative electrode material was then subjected to a CVD treatment to coat the battery negative electrode material with pyrolytic carbon by replacing the nitrogen gas flowing into the reaction tube with a mixed gas of hexane and nitrogen gas. The infusion rate of hexane was 0.3 g/min, and after infusion for 80 minutes, the supply of hexane was stopped. After the gas inside the reaction tube was replaced with nitrogen, the sample was allowed to cool, and a battery negative electrode material of Example 1 was obtained.

### Example 2

A battery negative electrode material having a content amount of silicon material of 15 mass % was obtained as Example 2 by the same manufacturing method as that of Example 1 with the exception that the mixing ratio between the nano silicon having an average particle size of 60 nm and the petroleum pitch was changed.

### Example 3

A battery negative electrode material having a content amount of silicon material of 12 mass % was obtained as Example 3 by the same manufacturing method as that of Example 1 with the exception that nano silicon (available from Sigma-Aldrich) having an average particle size of 100 nm was used, and the mixing ratio between the nano silicon and the petroleum pitch was changed.

### Example 4

A battery negative electrode material having a content amount of silicon material of 6 mass % was obtained as Example 4 by the same manufacturing method as that of Example 3 with the exception that mixing ratio between the nano silicon having an average particle size of 100 nm and the petroleum pitch was changed.

### Example 5

An electrode was fabricated using the battery negative electrode material of Example 1 as a battery negative electrode material of Example 5, and using polyvinylidene fluoride (KF9100 available from Kureha Corporation) as the binder, and battery evaluations were conducted.

### Example 6

An infusible finely pulverized composite pitch was prepared with the same method as that of Example 1, and the pitch was then heat treated in a nitrogen gas atmosphere at 600° C. for one hour. The sample was re-pulverized with a mill, and was then inserted into a container containing a 5 mass % hydrofluoric acid aqueous solution, and stirred for 60 minutes in a dark room at room temperature in an argon gas atmosphere to thereby remove the silicon oxide from the coated silicon material area 10′. Main firing and CVD were carried out with the same methods as those of Example 1, and thereby a battery negative electrode material of Example 6 was obtained.

### Comparative Example 1

Petroleum pitch having a softening point of 205° C. and an H/C atom ratio of 0.65 was coarsely pulverized using a hammer mill, and was then subsequently pulverized using a jet mill (100-AFG, available from Hosokawa Micron Corporation) until the average particle size was 12 μm, and a finely pulverized composite pitch was obtained. The finely pulverized pitch was heated to 260° C. and held for one hour at 260° C. and oxidized, and thereby heat-infusible oxidized pitch was obtained.

Next, 50 g of the oxidized pitch was inserted into a vertical tube furnace 50 mm in diameter, heated to 600° C. at a temperature increasing rate of 100° C./h, and then held at 600° C. for one hour to perform preliminary firing, and a carbon precursor was obtained. Preliminary firing was performed in a nitrogen atmosphere with a flow rate of 5 L/min.

Next, 10 g of this powdery carbon precursor was inserted into a horizontal tubular furnace with a diameter of 100 mm, heated to 1100° C. at a temperature increasing rate of 250° C./h, and held for one hour at 1100° C. and then subjected to main firing to thereby prepare a battery negative electrode material of Comparative Example 1. The main firing was performed in a nitrogen atmosphere with a flow rate of 10 L/min.

### Comparative Example 2

An electrode for testing was fabricated with the above-described procedures using, as the battery negative electrode material, a battery negative electrode material of Comparative Example 2 made from only nano silicon (from Sigma-Aldrich) having an average particle size of 100 nm, and battery evaluations were conducted.

### Comparative Example 3

The battery negative electrode material of Comparative Example 1 and the nano silicon used in Example 3 were mixed, and a battery negative electrode material having a content amount of silicon material of 15 mass % was obtained as Comparative Example 3.

### Comparative Example 4

A battery negative electrode material having a silicon material content of 17 mass % was obtained as Comparative Example 4 through the same method as that of Example 3 with the exception that step (b) was not implemented.

### Comparative Example 5

A battery negative electrode material was obtained as Comparative Example 5 by the same method as that of Example 6 with the exception that fusible pitch not subjected to an infusibilization treatment was used.

### Comparative Example 6

A battery negative electrode material was obtained as Comparative Example 6 by the same method as that of Example 3 with the exception that the average particle size of the coated silicon material (Si/SiO₂) was 3000 μm.

### Comparative Example 7

A battery negative electrode material was obtained as Comparative Example 7 by the same method as that of Example 1 of Patent Document 1.

### Comparative Example 8

Step (c) was carried out using the finely pulverized composite pitch prior to the implementation of step (b) in Example 3, after which step (b) was carried out, and a battery negative electrode material was obtained as Comparative Example 8.

The steps used in Examples 1 to 6 and Comparative Examples 1 to 8 are shown in Table 1. The characteristics of the battery negative electrode materials obtained in the examples and comparative examples, and the measurement results of the electrodes produced using these negative electrode materials and the battery performance values are shown in Table 2.

TABLE 1

| | Order of Step (b): | |
|---|---|---|
| | SiO₂ Removal | Step (d): Carbon |
| | and Step (c): Carbonizing | Coating Formation |
| Example 1 | (b)→(c) | (d) |
| Example 2 | (b)→(c) | (d) |
| Example 3 | (b)→(c) | (d) |
| Example 4 | (b)→(c) | (d) |
| Example 5 | (b)→(c) | (d) |
| Example 6 | (c)→(b) | (d) |
| Comparative Example 1 | — | — |
| Comparative Example 2 | — | — |
| Comparative Example 3 | — | — |
| Comparative Example 4 | (c) only | (d) |
| Comparative Example 5 | (c)→(b) | (d) |
| Comparative Example 6 | (b)→(c) | (d) |
| Comparative Example 7 | (b) only | (d) |
| Comparative Example 8 | (c)→(b) | (d) |

TABLE 2-1

| | Si Content | Presence of 1000 nm or | d₀₀₂ | Cavity | ρ_{He} | |
|---|---|---|---|---|---|---|
| | (mass %) | Larger Silicon Material | (nm) | Ratio (%) | (g/cm³) | H/C |
| Example 1 | 17 | None | 0.385 | 8.5 | 1.70 | 0.03 |
| Example 2 | 15 | None | 0.386 | 7.5 | 1.57 | 0.04 |
| Example 3 | 12 | None | 0.384 | 6.5 | 1.78 | 0.03 |
| Example 4 | 6 | None | 0.382 | 3.9 | 1.72 | 0.04 |
| Example 5 | 17 | None | 0.385 | 8.5 | 1.70 | 0.03 |
| Example 6 | 14 | None | 0.382 | 19.2 | 1.73 | 0.04 |
| Comparative | 0 | None | 0.383 | 0 | 2.04 | 0.03 |
| Example 1 | | | | | | |
| Comparative | 100 | None | — | — | 2.33 | — |
| Example 2 | | | | | | |
| Comparative | 15 | None | 0.384 | 0 | 2.13 | 0.03 |
| Example 3 | | | | | | |
| Comparative | 17 | None | 0.381 | 0 | 2.07 | 0.04 |
| Example 4 | | | | | | |
| Comparative | 14 | None | 0.361 | 9.9 | 1.73 | 0.05 |
| Example 5 | | | | | | |
| Comparative | 12 | Present | 0.381 | 23.2 | 1.78 | 0.04 |
| Example 6 | | | | | | |
| Comparative | 65 | None | 0.348 | 18.2 | 1.62 | 0.09 |
| Example 7 | | | | | | |
| Comparative | 20 | None | 0.380 | 2.1 | 1.72 | 0.03 |
| Example 8 | | | | | | |

TABLE 2-2

| | Charge | Discharge | Irreversible | Initial | Expansion | Capacity |
|---|---|---|---|---|---|---|
| | capacity | capacity | capacity | efficiency | ratio | retention |
| | (mAh/g) | (mAh/g) | (mAh/g) | (%) | (%) | rate (%) |
| Example 1 | 1104 | 891 | 213 | 80.7 | 114 | 92 |
| Example 2 | 1020 | 847 | 173 | 83.0 | 101 | 92 |
| Example 3 | 936 | 760 | 176 | 81.2 | 113 | 93 |
| Example 4 | 950 | 759 | 191 | 80.0 | 118 | 94 |
| Example 5 | 1150 | 918 | 232 | 79.8 | 120 | 90 |
| Example 6 | 983 | 795 | 188 | 80.9 | 105 | 93 |
| Comparative | 683 | 533 | 151 | 78.0 | 102 | 94 |
| Example 1 | | | | | | |
| Comparative | 2429 | 322 | 2107 | 13.2 | 372 | 24 |
| Example 2 | | | | | | |
| Comparative | 984 | 776 | 208 | 78.9 | 198 | 70 |
| Example 3 | | | | | | |
| Comparative | 1158 | 893 | 182 | 77.1 | 265 | 62 |
| Example 4 | | | | | | |
| Comparative | 849 | 594 | 255 | 70.0 | 151 | 82 |
| Example 5 | | | | | | |
| Comparative | 1077 | 824 | 252 | 76.6 | 206 | 52 |
| Example 6 | | | | | | |
| Comparative | 3203 | 2316 | 887 | 72.3 | 162 | 41 |
| Example 7 | | | | | | |
| Comparative | 951 | 648 | 303 | 68.1 | 174 | 80 |
| Example 8 | | | | | | |

According to results obtained by observing cross-sections with an SEM, the battery negative electrode materials of Examples 1 to 6 all had structures in which a carbon material area was formed, separated by a cavity, in a surrounding area of the silicon material area. As shown in Table 2, the average interlayer spacings d₀₀₂ of the battery negative electrode materials of Examples 1 to 6 were all from 0.365 nm to 0.390 nm. An average interlayer spacing d₀₀₂ of from 0.365 nm to 0.390 nm indicates that the carbon material is non-graphitizable carbon (hard carbon). Cavities are produced between the silicon material particles and the carbon material particles due to expansion and contraction in association with lithium doping and de-doping, and regardless of whether lithium is doped, the matter of contact being lost between the silicon material particles and the carbon material particles and the conductive network being interrupted is suppressed by making the carbon material non-graphitizable.

Therefore, when the battery negative electrode material of Examples 1 to 6 are used, both a merit of high specific capacity obtained by using the silicon material, and a merit of high cycle durability obtained by using a non-graphitizable carbon (hard carbon) can be obtained.

On the other hand, when, the case (Comparative Example 1) where the battery negative electrode material was not provided with silicon material areas exhibited inferior specific capacity compared to the battery negative electrode materials of Examples 1 to 6. This was because the specific capacity of the carbonaceous material was lower than that of the silicon material.

The case (Comparative Example 2) where the battery negative electrode material was not provided with a carbon material area exhibited inferior cycle durability compared to the battery negative electrode materials of Examples 1 to 6. This was because the cycle durability when silicon material was used as the negative electrode was lower than the cycle durability when the carbonaceous material was used.

The cases (Comparative Examples 3 and 4) where the battery negative electrode material was not provided with cavities in the areas surrounding the silicon material areas exhibited inferior cycle durability compared to the battery negative electrode materials of Examples 1 to 6. This is speculated to be because the size of the cavities was not sufficient, and when the silicon areas expanded in association with lithium ion doping, the battery negative electrode material was fractured due to that expansion.

For the case (Comparative Example 5) where a composite was formed with graphitizable carbon, sufficient cycle durability could not be obtained. This is speculated to be attributed to expansion and contraction between carbon layers with the (002) average interlayer spacing d₀₀₂ being 0.361 nm, which is narrow.

When the maximum particle size of the silicon material was 1000 nm or greater (Comparative Example 6), sufficient cycle durability could not be obtained. This is speculated to be because the silicon material cracked due to volume expansion of the silicon material during charging.

For the case (Comparative Example 7) where a carbon coating was formed on the silicon material without carrying out step (a), sufficient cycle durability could not be obtained. This is speculated to be because the carbon coating was thin, and when the electrode was pressed, the coating fractured, and the surface newly contacting the electrolyte solution increased.

For the case (Comparative Example 8) where step (b) was performed after the main firing, sufficient cycle durability could not be obtained. This is speculated to be attributed to the inability of the hydrofluoric acid aqueous solution to sufficiently permeate into the finely pulverized composite pitch, resulting in the inability to form sufficient cavities through the removal of the silicon oxide film.

### REFERENCE SIGNS LIST

1 Battery negative electrode material
10 Silicon material area
20 Carbon material area
30 Cavity

1. A method for manufacturing a battery negative electrode material, the battery negative electrode material being a composite substance comprising silicon material areas of a silicon material, and a carbon material area of a carbon material, formed in a surrounding area of the silicon material areas, separated by cavities at least at a portion;
the method comprising steps (a) to (c):
step (a): mixing an organic material composition and a coated silicon material that is a silicon precursor coated with silicon oxide and obtaining a composite substance of the organic material composition and the coated silicon material;
step (b): removing the silicon oxide from a composite substance resulting from the step (a); and
step (c): carbonizing an organic material constituting the organic material composition by subjecting a composite substance resulting from the step (b) to a main firing at a temperature of 1,000° C. to 1,500° C. in a non-oxidizing gas atmosphere;
wherein an (002) average interlayer spacing d₀₀₂ of the carbon material area determined by powder X-ray diffraction using CuKα rays is from 0.365 nm to 0.390 nm, and
wherein a maximum particle size of the coated silicon material is 1,000 nm or less.

2. The method for manufacturing a battery negative electrode material according to claim 1, wherein the step (a) further comprises an infusibilization treatment to the obtained composite substance.

3. The method for manufacturing a battery negative electrode material according to claim 1, further comprising a step (d): coating a composite substance resulting from the step (c) with a pyrolytic carbon.

4. The method for manufacturing a battery negative electrode material according to claim 1, wherein the organic material composition comprises at least one selected from the group consisting of petroleum-based pitch, petroleum-based tar, coal-based pitch, and coal-based tar.

5. The method for manufacturing a battery negative electrode material according to claim 1, wherein the composite substance obtained in the step (a) is a composite substance in which the coated silicon material is dispersed in the organic material composition.

6. The method for manufacturing a battery negative electrode material according to claim 1, wherein the content amount of the silicon material is 5 mass % or greater and 25 mass % or less relative to 100 mass % of the negative electrode material.
